(19) United States
(12) Patent Application Publication
(10) Pub. No.: US 2007/0040509 A1
(43) Pub. Date: Feb. 22, 2007

(54) Electric lamp with an optical interference film

(75) Inventors: Rob Van Wijk, Sint Oedenrode (NL); Bruno Thoennessen, Simmerath (DE); Georg Henninger, Aachen (DE); Herbert Gilles, Aachen (DE); Wolfgang Doetter, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/572,840

(22) PCT Filed: Sep. 15, 2004
(86) PCT No.: PCT/IB04/51765

§ 371 Date: Mar. 21, 2006

(30) Foreign Application Priority Data
Sep. 23, 2003 (EP) 03103507.4

(51) Int. Cl. H01J 61/35; H01J 17/16

(52) U.S. Cl. 313/635

(57) ABSTRACT

An electric lamp has an outer lamp envelope (1) enclosing a light-transmitting inner lamp vessel (2) in a gastight manner. A light source (3) is arranged in the inner lamp vessel. An optical interference film (4) is provided on at least part of an inner surface of the outer lamp envelope or on at least part of an outer surface of the inner lamp vessel. The optical interference film comprises a plurality of alternating high and low refractive index layers, the material of the high refractive index layer comprising substantially zirconium oxide. Preferably, the ratio of the volume Vᵢₗᵥ of the inner lamp vessel to the volume Vₒₗₑ outer lamp envelope (1) is: Vᵢₗᵥ/Vₒₗₑ≦0.5, preferably ≦0.25.

The invention relates to an electric lamp comprising an outer envelope enclosing in a gastight manner an inner lamp vessel and comprising an optical interference film.

Such electric lamps are in particular halogen lamps comprising an incandescent light source arranged in an inner lamp vessel which is hermetically sealed in an outer envelope. In addition, the electric lamps may also be discharge lamps where, in operation, the arc discharge functions as the light source. Such electric lamps are, for instance, used in automotive applications, for example as a (halogen or discharge) headlamp, in operation emitting yellow light, as an amber-colored light source in indicator lamps (also referred to as “vehicle signal lamps”) or as a red-colored light source in brake lights. Said electric lamps are further used in traffic and direction signs, contour illumination, traffic lights, projection illumination and fiber-optics illumination. Alternative embodiments of such electric lamps comprise lamps wherein the color temperature is changed and/or infrared radiation is contained in the lamp vessel by means of suitable optical interference films. Electric lamps of the kind as mentioned in the opening paragraph also find application for general illumination purposes, such as shop lighting, home lighting, accent lighting, spot lighting, theater lighting, fiber-optics applications, and projection systems.

The optical interference films reflect and/or allow passage of radiation originating from different parts of the electromagnetic spectrum, for example ultraviolet, visible and/or infrared fight. Such optical interference films are customarily provided as a coating on (the lamp vessel of) electric lamps and/or on reflectors.

The optical interference films are commonly applied for infrared-reflective reflection (energy saving), color-correction, UV-blocking, daylight coatings, partial coatings, back-mirror coatings, etc. In addition, the interference filters are usually deposited on the outer surface of the lamp vessel. Because operational conditions of most lamps result in high temperatures of the envelope (typically in the range from 400° C. to approximately 1000° C.), thermal stability of such interference coatings is desirable. Because of this, such interference filters typically comprise stacked layers of silicon oxide (SiO₂) as the low refractive index material and a metal-oxide exhibiting a higher index of refraction. Well-known metal-oxides applied are: titanium oxide (TiO₂), niobium oxide (Nb₂O₅), tantalum oxide (Ta₂O₅), zirconium oxide (ZrO₂) and mixtures thereof, the exact choice of material depending on the thermal load of the substrate.

The optical interference film may be provided in a customary manner by means of, for example, vapor deposition (PVD: physical vapor deposition) or by (reactive) sputtering or by means of a dip-coating or spraying process or by means of LP-CVD (low-pressure chemical vapor deposition), PE-CVD (plasma-enhanced CVD) or PI-CVD (plasma impulse chemical vapor deposition).

An electric lamp comprising an optical interference filter is known from U.S. Pat. No. 4,017,758. The known electric lamp comprises a hard glass outer lamp envelope enclosing, in a gastight manner, a light-transmitting quartz glass inner lamp vessel. An incandescent light source is arranged in the inner lamp vessel. The optical interference film transmits visible light and reflects infrared radiation and consists of an optical interference film and a heavily doped metal oxide film disposed on an inner surface of the outer lamp envelope.

A drawback of the known electric lamp is that degradation of the optical interference film occurs; in particular when the optical interference film is disposed on the inner lamp vessel enclosed is an outer envelope.

The invention has for its object to provide an electric lamp wherein said drawback is obviated. According to the invention, an electric lamp of the kind mentioned in the opening paragraph for this purpose comprises:

an outer lamp envelope enclosing, in a gastight manner, a light-transmitting inner lamp vessel,

a light source being arranged in the inner lamp vessel,

an optical interference film being provided on at least part of an inner surface of the outer lamp envelope or on at least part of an outer surface of the inner lamp vessel,

the optical interference film comprising a plurality of alternating high and low refractive index layers,

the material of the high refractive index layer comprising substantially zirconium oxide.

In the description and claims of the current invention, the designation “gastight” is used to refer to conditions where no oxygen has (intentionally) been added to the sealed space in the outer envelope. In practically all applications, the optical interference films of the known electric lamps are in direct contact with air or are at least indirectly in contact with air. If the optical interference film is disposed in a gastight electric lamp (such as, for instance, in a hermetically sealed PAR reflector), it is known to add a (weakly) oxidizing gas to a gastight electric lamp in which the optical interference film is disposed in order to diminish the degradation of the optical interference film. Moreover, such oxidation results in a lowering in the partial oxygen pressure in the filling gas minimizing the effectiveness of the oxidation on the degradation of the optical interference film.

Surprisingly, an optical interference film based on zirconium oxide remains stable during life under the operational conditions in an electric lamp with an outer lamp envelope enclosing, in a gastight manner, a light-transmitting inner lamp vessel. It is known that optical interference films tend to degrade when the electric lamp is in operation. In particular, the optical and mechanical stability of the known optical interference films show significant degradation during and after thermal cycling between room temperature and at a temperature of at least 1000° C. Even the well-known and broadly applied tantalum oxide (Ta₂O₅) shows degradation when applied in an optical interference film in an electric lamp with an outer lamp envelope enclosing a light-transmitting inner lamp vessel in a gastight manner.

Not wishing to be held to any particular theory, the inventors believe that during operation of the electric lamp, hydrogen is released from the burner envelope: other layer materials thermally stable at elevated temperature, including tantalum oxide (Ta₂O₅), are reactive to hydrogen and degrade while zirconium oxide (ZrO₂) remains stable. In addition, the hydrogen released from the glass wall will be oxidized by any oxygen dosed in the gas atmosphere. Once any oxygen in the sealed space has been consumed, the hydrogen will start attacking the optical interference film including tantalum oxide, but with the exception of zirconium oxide.

It is known that when an optical interference film is disposed in a gastight electric lamp, the volume of the electric lamp has to be taken sufficiently large in order to diminish the effect of the degradation. However, when applying zirconium oxide, the volume ratio can be much smaller than what is known in the art. To this end a preferred embodiment of the electric lamp in accordance with the invention is characterized in that the ratio of the volume Vᵢₗᵥ of the inner lamp vessel and the volume Vₒₗₑ outer lamp envelope is:

$$\frac{{V}_{ilv}}{{V}_{ole}} \leq 0.5 .$$

Preferably, the ratio of the volume Vᵢₗᵥ of the inner lamp vessel and the volume Vₒₗₑ outer lamp envelope is:

$$\frac{{V}_{ilv}}{{V}_{ole}} \leq 0.25 .$$

In other words, even if the volume ratio burner/envelope is smaller than 1:4, degradation of zirconium oxide in an electric lamp with an outer lamp envelope enclosing a light-transmitting inner lamp vessel in a gastight manner.

Preferably, the optical interference film is arranged on at least a part of the outer surface of the inner lamp vessel. When the optical interference film comprising zirconium oxide as the high refractive index layer is disposed on the outer surface of the inner lamp vessel, the optical interference film exhibits little or no degradation during and after thermal cycling between room temperature and at temperature of at least 1000° C.

These and other aspects of the invention will be apparent from and elucidated with reference to the embodiment(s) described hereinafter.

In the drawings:

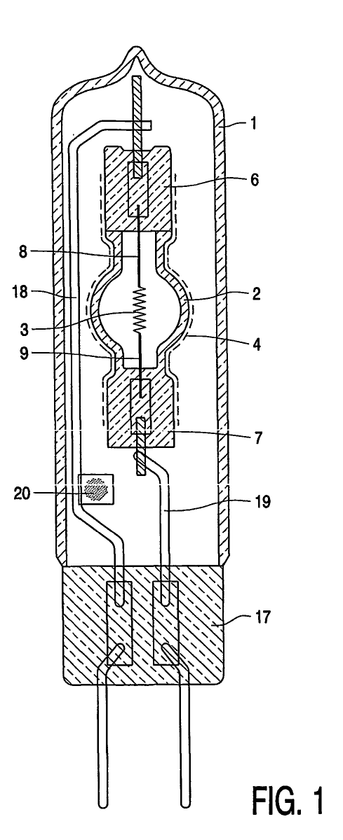

FIG. 1 is a cross-sectional view of an embodiment of the electric lamp according to the invention.

The Figures are purely schematic and not drawn to scale. Particularly for clarity, some dimensions are strongly exaggerated. In the Figures, like reference numerals refer to like parts whenever possible.

FIG. 1 is a cross-sectional view of an embodiment of the electric lamp in accordance with the invention. The electric lamp comprises an outer lamp envelope 1 enclosing, in a gastight manner, a light-transmitting inner lamp vessel 2. Gastight means that there is no open connection to air, nor that there has been any oxygen intentionally dosed to the gas atmosphere in order to maintain a significant partial oxygen pressure inside the outer lamp envelope during the life of the electrical lamp under operational conditions. The outer lamp envelope 1 is for instance made of hard glass or quartz glass. The inner lamp vessel 2 is for instance made of hard glass, quartz glass or of polycrystalline aluminum oxide (PCA). A light source 3 is arranged in the inner lamp vessel 2. In the example of FIG. 1, the light source 3 is a (spiral-shaped) tungsten incandescent body. In an alternative embodiment two electrodes are arranged in the lamp vessel between which, in operation, an arc discharge is maintained. In the example of FIG. 1, the inner lamp vessel 2 is a so-called double-ended lamp vessel having a first 6 and a second 7 end portion arranged at opposite sides of the inner lamp vessel 2. Current-supply conductors 8, 9 electrically connected to the light source 3 issue from the inner lamp vessel 2 via Mo-foils in the first and second end portions 6, 7. The inner lamp vessel 2 in FIG. 1 is arranged in the outer lamp envelope 1 in a manner that a so-called single-ended electric lamp is obtained with a further single end portion 17. Further current-supply conductors 18; 19 electrically connected to the respective current-supply conductors 8; 9 issue from the outer lamp envelope 1 to the exterior via Mo-foils in the further end portion 17. Preferably, the further current-supply conductors 18; 19 are decarburized by means of an oxidation process minimizing the carbon contamination level of these connectors. Preferably, zirconium oxide is applied under carbon-free atmospheric conditions. A getter 20 may be present in the gastight space surrounding the inner lamp vessel 2.

In the example of FIG. 1, an optical interference film 4 is provided on at least a part of the outer surface of the inner lamp vessel 2. In an alternative embodiment of the electric lamp according to the invention, the optical interference film is arranged on one of the inner surfaces of the outer lamp envelope. The optical interference film 4 comprises a plurality of alternating high and low refractive index layers, the material of the high refractive index layer comprising substantially zirconium oxide (ZrO₂). Preferably, the low refractive index layer material comprises substantially silicon oxide (SiO₂).

An optical interference film with zirconium oxide as a high refractive index layer remains stable during life under the operational conditions in an electric lamp with an outer lamp envelope enclosing a light-transmitting inner lamp vessel in a gastight manner. Zirconium oxide appears to be the only material suitable for use in an optical interference film which is thermally and chemically inert to degradation under operational conditions in such electric lamps. It is well known that optical interference films, in particular the layers of the high refractive index materials, tend to degrade when the electric lamp is in operation. In particular, the optical and mechanical stability of the known optical interference films show significant degradation during and after thermal cycling between room temperature and at a temperature of at least 1000° C. Even the well-known and broadly applied tantalum oxide (Ta₂O₅) shows degradation when applied in an optical interference film in an electric lamp with an outer lamp envelope enclosing, in a gastight manner, a light-transmitting inner lamp vessel.

When an optical interference film is disposed in a gastight electric lamp (such as, for instance, in a hermetically sealed PAR reflector), the effect of degradation can be diminished if the volume of the electric lamp is taken sufficiently large. However, when applying zirconium oxide, the volume ratio can be much smaller than what is known in the art. Preferably, the ratio of the volume Vᵢₗᵥ of the inner lamp vessel to the volume Vₒₗₑ outer lamp envelope is:

$$\frac{{V}_{ilv}}{{V}_{ole}} \leq 0.5 .$$

Preferably, the ratio of the volume Vᵢₗᵥ of the inner lamp vessel to the volume Vₒₗₑ outer lamp envelope is:

$$\frac{{V}_{ilv}}{{V}_{ole}} \leq 0.25 .$$

In other words, even if the volume ratio burner/envelope is smaller than 1:4, degradation of zirconium oxide is diminished in an electric lamp with an outer lamp envelope enclosing a light-transmitting inner lamp vessel in a gastight manner. A very favorable volume ratio is approximately 0.18.

Preferably, the optical interference film 4 is arranged on at least a part of the outer surface of the inner lamp vessel 2 (see FIG. 1). When the optical interference film comprising zirconium oxide as the high refractive index layer is disposed on the outer surface of the inner lamp vessel, the optical interference film exhibits little or no degradation during and after thermal cycling between room temperature and at a temperature of at least 1000° C. A preferred embodiment of the electric lamp in accordance with the invention is characterized in that the optical interference film 4 transmits visible radiation and reflects infrared radiation or the optical interference film changes the color temperature of the electric lamp. Preferably, the light source 3 comprises at least one incandescent lamp body or an arc of a discharge lamp in operation. The electric lamp, preferably, comprises a halogen lamp.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a”, or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An electric lamp comprising:
an outer lamp envelope (1) enclosing a light-transmitting inner lamp vessel (2) in a gastight manner,
a light source (3) being arranged in the inner lamp vessel (2),
an optical interference film (4) being provided on at least part of an inner surface of the outer lamp envelope (1) or on at least part of an outer surface of the inner lamp vessel (2),
the optical interference film (4) comprising a plurality of alternating high and low refractive index layers,
the material of the high refractive index layer comprising substantially zirconium oxide.

2. An electric lamp as claimed in claim 1, characterized in that the ratio of the volume Vᵢₗᵥ of the inner lamp vessel (2) to the volume Vₒₗₑ outer lamp envelope (1) is:
$$\frac{{V}_{ilv}}{{V}_{ole}} \leq 0.5 .$$

3. An electric lamp as claimed in claim 2, characterized in that the ratio of the volume Vᵢₗᵥ of the inner lamp vessel (2) to the volume Vₒₗₑ outer lamp envelope (1) is:
$$\frac{{V}_{ilv}}{{V}_{ole}} \leq 0.25 .$$

4. An electric lamp as claimed in claim 1, characterized in that the optical interference film (4) is arranged on at least part of the outer surface of the inner lamp vessel (1).

5. An electric lamp as claimed in claim 1, characterized in that the material of the low refractive index layer comprises substantially silicon oxide.

6. An electric lamp as claimed in claim 1, characterized in that the optical interference film (4) transmits visible radiation and reflects infrared radiation or the optical interference film (4) changes the color temperature of the electric lamp.

7. An electric lamp as claimed in claim 1, characterized in that the light source (3) comprises at least one incandescent lamp body or an arc of a discharge lamp in operation.

8. An electric lamp as claimed in claim 1, characterized in that the electric lamp comprises a halogen lamp.
